(19) United States
(12) Patent Application Publication
(10) Pub. No.: US 2022/0129017 A1
(43) Pub. Date: Apr. 28, 2022

(54) FLIGHT BODY, INFORMATION PROCESSING METHOD, AND PROGRAM

(71) Applicant: Sony Group Corporation, Tokyo (JP)

(72) Inventor: Masato NOGUCHI, Tokyo (JP)

(73) Assignee: Sony Group Corporation, Tokyo (JP)

(21) Appl. No.: 17/422,754

(22) PCT Filed: Nov. 25, 2019
(86) PCT No.: PCT/JP2019/045967

§ 371 Date: Jul. 14, 2021

(30) Foreign Application Priority Data
Feb. 18, 2019 (JP) 2019-026445

(51) Int. Cl. G05D 1/12; H04N 5/232; G06T 7/20; G06T 7/70; G05D 1/10; B64C 39/02

(52) U.S. Cl. CPC G05D 1/12; H04N 5/232; G06T 7/20; G06T 7/70; B64C 2201/123; B64C 39/024; G06T 2207/30244; G06T 2207/10032; G05D 1/101

(57) ABSTRACT

A flight body including a recognition unit that recognizes a current position of a moving subject that is a tracking subject; a storage unit that stores control information corresponding to each of a plurality of scheduled positions of the moving subject; a calculation unit that calculates control target information corresponding to the current position of the moving subject recognized by the recognition unit on a basis of the control information; and a control unit that performs control according to the control target information.

### TECHNICAL FIELD

The present technology relates to a flight body, an information processing method, and a program.

### BACKGROUND ART

Recently, using an unmanned autonomous flight body called a UAV (Unmanned aerial vehicle) and a drone, tracking and capturing a moving subject such as a car or a runner running at high speed are becoming easy (for example, see Patent Literature 1).

### CITATION LIST

### Patent Literature

Patent Literature 1: Japanese Patent Application Laid-open No. 2018-129063

### DISCLOSURE OF INVENTION

### Technical Problem

According to the technique described in Patent Literature 1, it is possible to track and capture a moving subject, but a realistic feeling or the like of an obtained image may become poor, for example, a capturing angle is fixed.

It is an object of the present disclosure to provide a flight body, an information processing method, and a program capable of obtaining an image of desired content relating to a moving subject which is a tracking subject.

### Solution to Problem

The present disclosure is, for example, a flight body including:

a recognition unit that recognizes a current position of a moving subject that is a tracking subject;

a storage unit that stores control information corresponding to each of a plurality of scheduled positions of the moving subject;

a calculation unit that calculates control target information corresponding to the current position of the moving subject recognized by the recognition unit on a basis of the control information; and

a control unit that performs control according to the control target information.

The present disclosure, for example, an information processing method, including:

recognizing a current position of a moving subject which is a tracking subject by a recognition unit;

storing control information corresponding to each of a plurality of scheduled positions of the moving subject by a storage unit;

calculating control target information corresponding to the current position of the moving subject recognized by the recognition unit on a basis of the control information by a calculation unit; and

performing control according to the control target information by a control unit.

The present disclosure, for example, is a program for causing a computer to execute an information processing method, the method including:

recognizing a current position of a moving subject which is a tracking subject by a recognition unit;

storing control information corresponding to each of a plurality of scheduled positions of the moving subject by a storage unit;

calculating control target information corresponding to the current position of the moving subject recognized by the recognition unit on a basis of the control information by a calculation unit; and

performing control according to the control target information by a control unit.

### BRIEF DESCRIPTION OF DRAWINGS

FIG. 1 is a drawing referred when explaining problems to be considered in embodiments.

FIG. 2 is a drawing for explaining a data format of a general flight plan.

FIG. 3 is a diagram for explaining an outline of the embodiment.

FIG. 4 is a block diagram showing an internal configuration example of a drone according to the embodiment.

FIG. 5 is a diagram for explaining a data format of a flight plan in the present embodiment.

FIG. 6 is a diagram for explaining an example of coordinate systems for defining control information and a control target value.

FIG. 7 is a flowchart showing a flow of processing performed by the drone according to the present embodiment.

FIG. 8 is a drawing referred when explaining a first processing example of calculating the control target value.

FIG. 9 is a drawing referred when explaining a second processing example of calculating the control target value.

FIG. 10 is a drawing for explaining a data format of a flight plan in a modification embodiment.

FIG. 11 is a drawing for explaining the modification embodiment.

FIG. 12 is a diagram for explaining another example of coordinate systems for defining control information and a control target value.

FIG. 13 is a drawing referred when explaining an application example of the present disclosure.

### MODE(S) FOR CARRYING OUT THE INVENTION

Embodiments and the like of the present disclosure will now be described below with reference to the drawings. Note that the description is made in the following order.

### <Problems to be Considered in Embodiments>

### <Embodiments>

### <Modification Embodiments>

### <Application Examples of Disclosure>

An embodiment and the like described below are favorable specific examples of the present disclosure, and content of the present disclosure is not limited to the embodiments and the like.

### Problems to be Considered in Embodiments

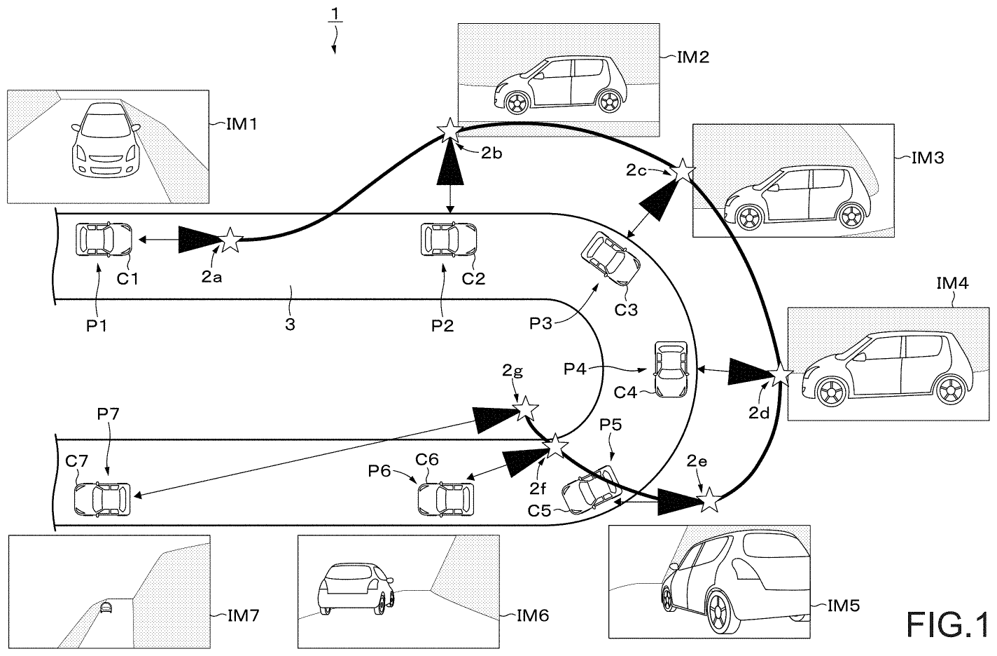

First, in order to facilitate understanding of the present disclosure, with reference to FIG. 1, a problem to be considered in the embodiments will be described. Incidentally, this embodiments will be described with reference to a car as a moving subject which is a tracking subject. In addition, as an example of a flight body, a drone that flies in the air and is capable of autonomously controlling will be described as an example.

FIG. 1 shows a capturing system (capturing system 1) in which the drone captures the car running at high speed. In the capturing system 1, a car C runs on a trajectory (in this embodiment, on road 3). A drone 2 tracks the car C running on the road 3, and the drone 2 captures the car C at predetermined positions (points). FIG. 1 shows seven capturing points P1 to P7 along with traveling of the car C, positions Cl to C7 of the car at respective capturing points, positions (indicated by stars) and capturing directions (indicated by arrows) 2a to 2f of the drone 2, and images IM1 to IM7 taken at respective capturing points are shown.

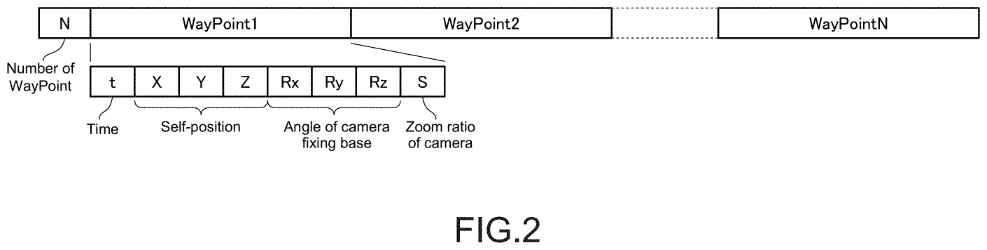

In general, a scheduled flight path of the drone 2 is defined by data called a flight plan. FIG. 2 shows a data format of a general flight plan. In the flight plan, a flight path of the drone 2 is defined as WayPoint rows. As shown in FIG. 2, each number N of the WayPoints is described in a header. Each WayPoint includes a time t (corresponding to capturing timing) from a reference time, a self-position of (drone 2) at time t, a setting of a camera (for example, angle of camera fixing base of drone 2 and a zoom ratio of camera). When the drone 2 flies according to the flight plan and the car C is captured based on a preset position and a camera parameter at each time, it is possible to capture the car C at an angle or the like intended at the time of creation of the flight plan.

As a method for capturing the tracking subject by the drone, a method for automatically tracking and capturing the subject is considered. In such a method, tracking and capturing are possible but the angle is fixed. That is, only images of the same angle can be obtained by capturing. Also, a method of creating the flight plan in which the angle is described as described above and causing the drone to fly according to the flight plan is conceivable. In such a method, it is necessary to adjust positions and postures of the car which is the tracking subject to a scheduled flight route of the drone described in the flight plan. Therefore, a skilled car operation technique is required, which may limit an environment in which the drone can be used. In addition, in a car race, it is impossible to adjust the positions and the postures of the car to the scheduled flight route of the drone. It is also conceivable to maneuver the drone manually. Such an approach may limit the environment in which the drone can be used because a skilled drone maneuvering technique is required. In addition, it is practically impossible to perform an operation of causing the car moving at high speed to follow the drone. While considering the above points, the embodiment of the present disclosure will be described.

### Embodiments

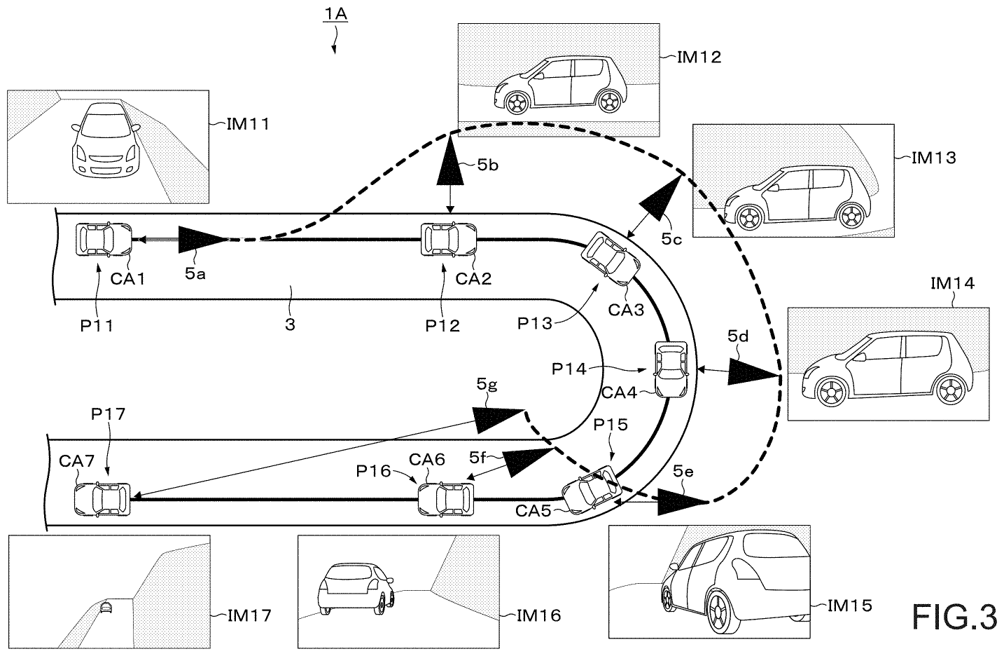

FIG. 3 is a diagram for explaining an outline of the embodiment. In the embodiment, similar to the above-described example, a car (car CA) running on the road 3 will be described with reference to a capturing system (capturing system 1A) for capturing using a drone (drone 5) according to the embodiment.

In the capturing system 1A, the car CA runs on the road 3. The drone 5 tracks the car CA running on the road 3 and captures the car C at predetermined positions (points). FIG. 3 shows seven capturing points P11 to P17, positions CA1 to CA7 of the car at respective capturing points, positions of the drone 5, capturing directions 5a to 5g, and images IM11 to IM17 captured at respective capturing points.

In the embodiment, an operation of the drone 5 is controlled so that the drone 5 exists at a relative position (position specified by control target value to be described later) with respect to a current position of the car CA. Therefore, when the car CA deviates from an assumed movement route, in other words, even when it is difficult to control the car CA with high accuracy, it is possible to capture the car CA based on a desired position and a setting of the camera. The embodiment thereof will be described below in detail.

### Example of Internal Configuration of Flight Body

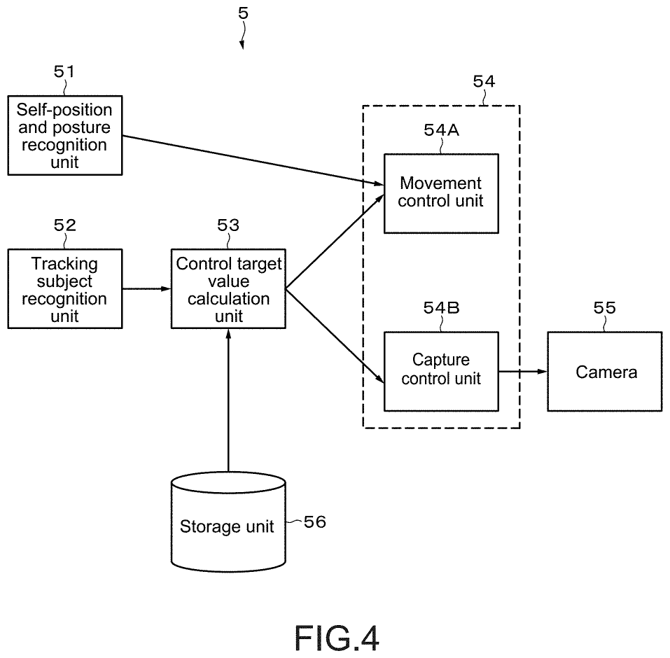

FIG. 4 is a block diagram showing an internal configuration example of the drone 5 according to the embodiment. The drone 5 includes, for example, a self-position and posture recognition unit 51, a tracking subject recognition unit 52 that is an example of a recognition unit, a control target value calculation unit 53 that is an example of a calculation unit, a control unit 54, a camera 55 that is an imaging unit, and a storage unit 56. The control unit 54 according to the present embodiment includes a movement control unit 54A and a capturing control unit 54B. The camera 55 is attached to a movable camera fixing base (not shown) provided on a body portion of the drone 5. A capturing angle is changed by an appropriate operation of the camera fixing base.

The self-position and posture recognition unit 51 recognizes the position and the posture of itself, that is, the drone 5. The self-position and posture recognition unit 51 recognizes its own position and posture by applying known methods based on information obtained from a GPS (Global Positioning System), an IMU (Inertial Measurement Unit) including an acceleration sensor and a gyro sensor, an image sensor, and the like.

The tracking subject recognition unit 52 recognizes current position and posture (hereinafter, referred to as current position or the like) of the moving subject (car CA in the present embodiment) which is the tracking subject. The current position or the like of the car CA is, for example, recognized based on an image obtained by the image sensor. The current position or the like of the car CA may be recognized based on a result of communication between the drone 5 and the car CA. For example, the current position or the like of the car CA may be transmitted from the car CA to the drone 5. The car CA acquires own current position or the like using the GPS, the IMU, etc., and transmits it to the drone 5. The current position or the like of the car CA may be recognized by a method combining these methods. Each of the current position and posture of the car CA is defined by an absolute coordinate system having three axes (X, Y, and Z axes).

Note that the moving subject is not limited to a single body. For example, it may be an abstract concept such as a “leading group” in a marathon relay (plural persons, animals, bodies, etc. existing within certain range). Moreover, the tracking subject of the tracking subject recognition unit 52 may be switched in response to an instruction by communication from an external device to the drone 5 or content of a program stored in the drone 5 in advance. In response to the instruction, the tracking subject recognition unit 52 switches the moving subject which is the tracking subject. As a specific example, in a soccer relay, a switching request to track a ball or a specific player may be supplied from the external device to the drone 5, and the moving subject which is the tracking subject may be switched. In this manner, the tracking subject recognition unit 52 may recognize the specified moving subject.

The control target value calculation unit 53 calculates and acquires a control target value (control target information) corresponding to the current position of the car CA recognized by the tracking subject recognition unit 52 based on control information. A specific example of the control information will be described later. The control target value according to the present embodiment is a control target value relating to the position where the drone 5 is present and the setting of the camera 55. The control target value relating to the posture of the drone 5 may be included. The setting of the camera 55 includes at least one of, for example, a setting of the angle of the camera fixture (camera posture) and/or a setting of a camera parameter. In the present embodiment, a zoom ratio will be described as an example as the camera parameter, but other parameters such as an F value and a shutter speed may be included.

The control unit 54 performs control according to the control target value calculated by the control target value calculation unit 53. Specifically, the movement control unit 54A controls a motor or the like of a propeller according to the control target value, and performs control to move its own position (position of drone 5) to a predetermined position. The capturing control unit 54B controls the angle of the camera fixing base and the value of the camera parameter according to the control target value. According to the control of the capturing control unit 54B, capturing of the car CA by the camera 55 is performed. The capturing of the car CA by the camera 55 may be capturing of still images or capturing of videos.

The storage unit 56 collectively refers to a program executed by the drone 5, a memory in which an image captured by the camera 55 is stored, and the like. Examples of the storage unit 56 include a magnetic storage device such as an HDD (Hard Disk Drive), a semiconductor storage device, an optical storage device, and a magneto-optical storage device. In this embodiment, data related to the flight plan is stored in the storage unit 56. Details of the flight plan will be described later.

An example of the internal configuration of the drone 5 according to the present embodiment is described above. It should be appreciated that the internal configuration example described above is an example and is not limited thereto. The drone 5 may have a control unit that collectively controls each unit, a communication unit that performs communication with the external device, and other configurations.

### About Flight Plan

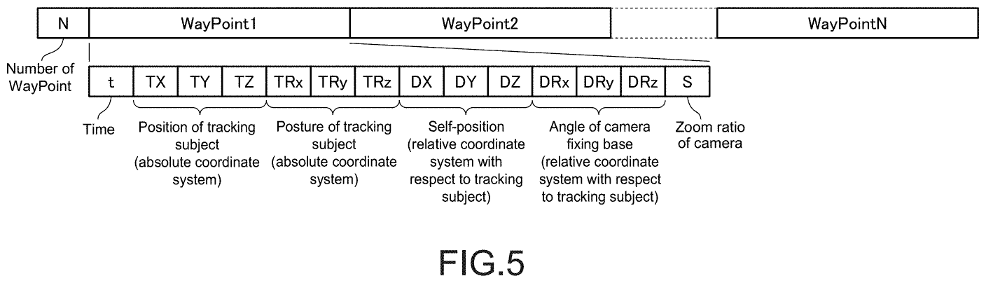

FIG. 5 is a diagram for explaining the data format of the flight plan in the present embodiment. As shown in FIG. 5, the flight plan in the present embodiment includes a plurality of WayPoint rows. Each number N of the WayPoints is described in the header. Each WayPoint includes the time t (corresponding to capturing timing) from the reference time, and a position (hereinafter, referred to as scheduled position as appropriate) and the posture of the tracking subject (car CA) in which the car CA is expected to exist at the time t. The scheduled position of the car CA is defined by the position (TX, TY, TZ) in the absolute coordinate system having three axes. The posture of the car CA is defined by the posture (TRx, TRy, TRz) in the absolute coordinate system having three axes.

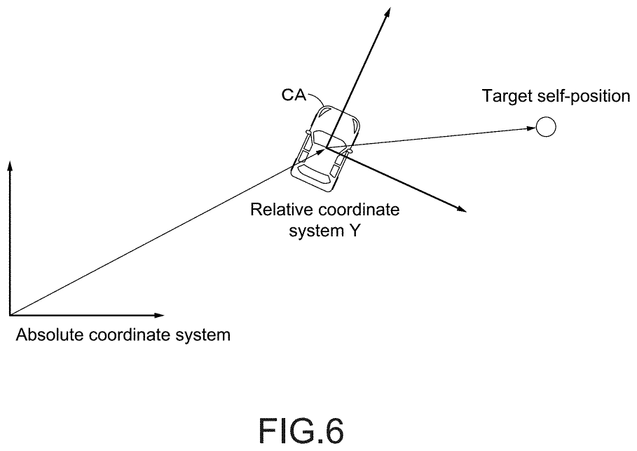

The control information corresponding to the scheduled position and posture of the car CA in each WayPoint is described in the WayPoints. The content of the control information includes the self-position (of drone 5), the angle of the camera fixing base, and a zoom ratio S. The self-position is defined by the position (DX, DY, DZ) in a relative coordinate system having three axes with respect to the car CA. The angle of the camera-fixing base is defined by the angle (DRx, DRy, DRz) in the relative coordinate system having the three axles with respect to the car CA. That is, the control information in the present embodiment is, as shown in FIG. 6, information to be set in the coordinate system in which a direction is determined by the posture of the car CA by setting the current position of the car CA as an origin. Therefore, the control target value calculated based on the control information as described later is also information to be set in the coordinate system in which the direction is determined by the posture of the car CA by setting the current position of the car CA as the origin. By employing such a coordinate system, even when the position and the posture of the car CA are deviated from the scheduled position and posture, the image captured by the camera 55 can be the image captured with the same angle of view as a scheduled angle of view for the car CA. As described above, the current position and posture of the car CA can be recognized by the tracking subject recognition unit 52. In FIG. 6, the Z axis is not shown.

The above-described control target value calculation unit 53 calculates the control target value corresponding to the current position of the car CA based on the control information described in the WayPoint. As a specific example, the control target value calculation unit 53 calculates the relative position corresponding to the current position of the car CA based on the position of the drone 5 described in the WayPoint.

### Drone Operation Example

### (Overall Processing Flow)

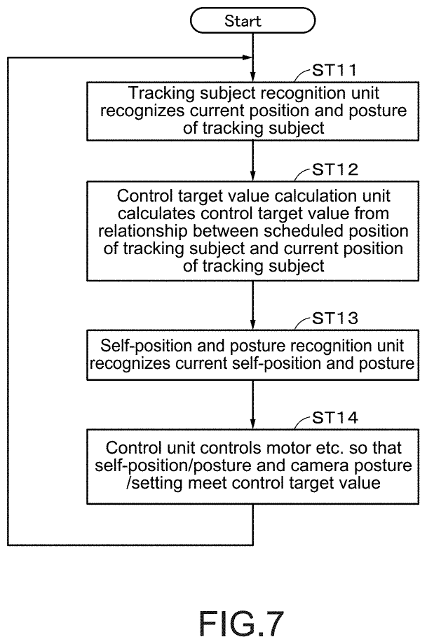

Next, an operation example of the drone 5 will be described with reference to a flowchart shown in FIG. 7. When the process is started, processing in Step ST11 is firstly performed. In Step ST11, the tracking subject recognition unit 52 recognizes the current position and posture of the car CA which is the tracking subject. Then, processing proceeds to Step ST12.

In Step ST12, the control target value calculation unit 53 calculates the control target value from a relationship between the scheduled position of the car CA described in the flight plan and the current position of the car CA actually observed. Then, processing proceeds to Step ST13.

In Step ST13, the self-position and posture recognition unit 51 recognizes the current self-position and posture. Then, processing proceeds to Step ST14.

In step ST14, the control unit 54 (movement control unit 54A and capturing control unit 54B) controls settings of a drive mechanism such as a motor and the camera 55 so that the self-position, the posture, the posture of the camera 55, and the setting of the camera parameter meet the control target value. Thus, the operation of the drone 5 is controlled so as to meet the control target value. The processing from Step ST11 to Step ST14 described above is repeated an appropriate number of times as the car CA runs.

### (Processing for Calculating Control Target Value)

Incidentally, since only discrete information is recorded in each WayPoint of the flight plan and there is no guarantee that the car CA is at the same position as the scheduled position in each WayPoint, the control target value needs to be calculated by interpolating the control information described in each WayPoint during a tracking flight. Hereinafter, two specific examples of the processing for calculating the control target value by interpolation will be described.

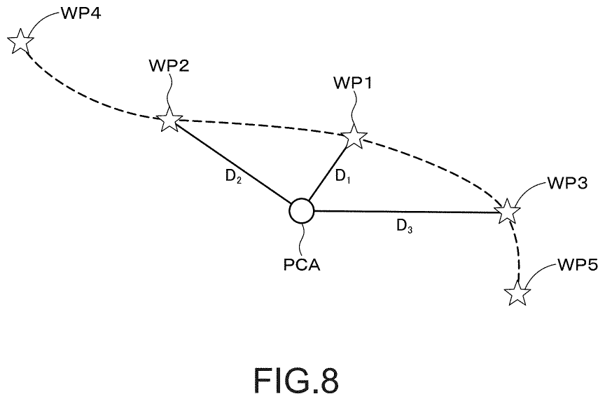

Referring to FIG. 8, a first processing example of calculating the control target value will be described. The first processing example is a processing example in which the interpolation is performed by focusing only on the relationship with an adjacent WayPoint without considering the scheduled time recorded in the WayPoint or its continuity. The first processing example is suitable for a use case in which the trajectory and a traveling direction of the subject are not fixed and the subject moves around randomly within a certain range (e.g., field sports relay, etc.).

Star marks in FIG. 8 indicate the scheduled positions of the car CA described in each WayPoint of the flight plan. A circle mark in FIG. 8 indicates the current position of the car CA (hereinafter, current position is referred to as current position PCA as appropriate) recognized by the tracking subject recognition unit 52. A dotted line in FIG. 8 is obtained as continuous data of the scheduled positions of the car CA described in the respective WayPoints and corresponds a route in which the car CA is scheduled to run (hereinafter, referred to as scheduled route as appropriate). Note that the scheduled route is shown for easy understanding, and the processing for obtaining the scheduled route is not necessarily required in this processing example.

First, the control target value calculation unit 53 refers to the flight plan stored in the storage unit 56 and extracts upper n pieces (about 2 to 5 pieces, 3 pieces in this embodiment) of the WayPoints in which the scheduled positions close to the current position PCA are described from the WayPoints in which the scheduled positions closest to the current position PCA are described. The extracted three pieces of the WayPoints are referred to as WayPoint-WP1, WayPoint-WP2, and WayPoint-WP3.

Next, the control target calculation unit 53 calculates distances Di between the CPA and the scheduled positions described in the extracted three pieces of the WayPoints. A distance D₁ is calculated as a distance between the schedule position described in the WayPoint-WP1 and the current position PCA, a distance D₂ is calculated as a distance between the scheduled position described in the WayPoint-WP2 and the current position PCA, and a distance D₃ is calculated as a distance between the scheduled position described in the WayPoint-WP3 and the current position PCA. In this embodiment, the distance D₁ has the smallest value.

The control information (self-position, camera angle, etc.) described in each of the three pieces of the WayPoints is used as control information Xᵢ. The control target value calculation unit 53 performs interpolation calculation by adding the control information Xᵢ by a reciprocal ratio of the distance Dᵢ for each content of the control information Xᵢ and calculates the control target value (X) as the calculation result. The interpolation calculation is performed by, for example, Equation 1 below.

$$\begin{matrix}[ Math . 1 ] & \\ X = \frac{{\sum }_{i = 0}^{n} {X}_{i} \times \frac{1}{{D}_{i}}}{{\sum }_{i = 0}^{n} \frac{1}{{D}_{i}}} & ( 1 )\end{matrix}$$

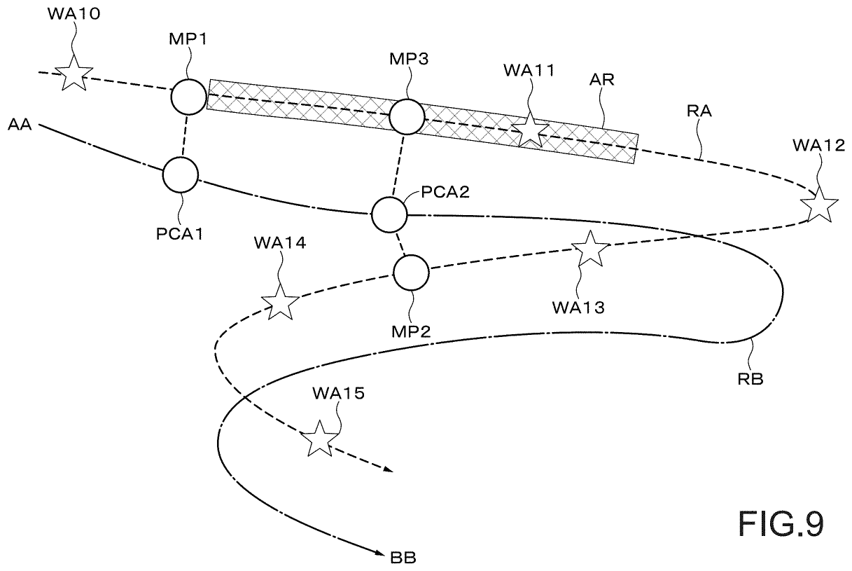

Next, a second processing example of calculating the control target value will be described with reference to FIG. 9. This processing example is a processing example in which the interpolation is performed on an assumption that the tracking subject moves according to the scheduled route, although some error occurs, by regarding time series described in the WayPoints as important. This processing example is suitable for a use case in which the subject passes through nearby points a plurality of times but suitable camera angles are different for the first and second passes such as a track competition and a marathon relay.

Star marks in FIG. 9 indicate the scheduled positions of the car CA described in the WayPoints of the flight plan. Circular marks on a dashed-dot line in FIG. 9 indicate the position of the car CA recognized by the tracking subject recognition unit 52. A dotted line in FIG. 9 is obtained as continuous data of the scheduled positions of the car CA described in the respective WayPoints (WayPoints-WA10 to WA15 in this embodiment) by spline interpolation or the like, and corresponds to the scheduled route of the car CA. The dashed-dot line in FIG. 9 indicates the actual running path RB of the car CA. The car CA runs in a direction from a reference sign AA to a reference sign BB on the running path RB.

The control target calculation unit 53 performs the spline interpolation on various pieces of information described in the WayPoints described in the flight plan, for example, to convert the WayPoints, which are discrete data, into continuous data, thereby obtaining a scheduled route RA. In the subsequent processing, the calculation using this continuous data is performed.

Here, it is assumed that a current position PCA1 is recognized as the current position of the car CA by the tracking subject recognition unit 52. The control target calculation unit 53 searches for a position closest (nearest neighbor position) to the current position PCA1 on the scheduled route RA. In this embodiment, it is assumed that a nearest neighbor position MP1 is searched as the position closest to the current position PCA1.

The control target value calculation unit 53 calculates a control target value corresponding to the nearest neighbor position MP1. The control target value calculation unit 53 calculates the control target value by performing weighted addition of control information of two WayPoints (WayPoints-WA10, WA11 in this embodiment) adjacent to the nearest neighbor position MP1 according to a distances from each WayPoint to the nearest neighbor position MP1, for example. The operation of the drone 5 is controlled based on the calculated control target value.

Then, it takes an example that the tracking subject recognition unit 52 recognizes a current position PCA2 as the current position of a next car CA. A position closest to the current position PCA2 in the scheduled route RA is a nearest neighbor position MP2. If the control target value corresponding to the nearest neighbor position MP2 is determined and applied in the same manner as described above, an angle of an image captured at the current position PCA2 of the car CA, a zoom ratio or the like may be significantly different from scheduled ones. Therefore, the nearest neighbor position corresponding to the current position of the car CA may be obtained within a certain range from the nearest neighbor position obtained last time. Specifically, a nearest neighbor position MP3 corresponding to the current position PCA2 is searched within a predetermined range AR from the nearest neighbor position MP1 obtained last time. The predetermined range from the nearest neighbor position MP1 obtained last time may be within a predetermined period of time, or may be within a predetermined range in the scheduled route RA.

The control target value calculation unit 53 calculates a control target value corresponding to the nearest neighbor position MP3. The control target value calculation unit 53 calculates the control target value by performing the weighted addition of the control information of the two WayPoints (WayPoint-WA10, WA11 in this embodiment) adjacent to the nearest neighbor position MP3 according to a distance from each WayPoint to the nearest neighbor position MP3, for example. Thus, when a search range of the nearest neighbor position is within the certain range, it is possible to prevent an image having a substantially different angle or the like from the schedules ones from being captured.

Incidentally, when calculating the nearest neighbor position, it may select a position for a constant time ahead as the nearest neighbor position in consideration of the time taken to actually move the motor from the recognition processing of the car CA.

The drone 5 may be made to be able to perform both of the above-described first and second processing examples. Depending on the application of the drone 5, it may be possible to set as a mode which of the first and second processing examples is to be performed.

### Effects Obtained by Embodiment

According to the present embodiments described above, for example, it is possible to obtain the image of the desired content relating to the moving subject which is the tracking subject. Even when the moving subject moves on the route different from the scheduled or assumed route, it is possible to capture the moving subject at an angle or the like intended at the time of creation of the flight plan. In addition, since it is unnecessary to finely specify the movement route of the drone, a flight plan can be easily created.

### Modification Embodiments

While the embodiments of the present disclosure are specifically described above, the content of the present disclosure is not limited to the above-described embodiments, and various modification embodiments based on the technical idea of the present disclosure can be made. Hereinafter, modification embodiments will be described.

### First Modification Embodiment

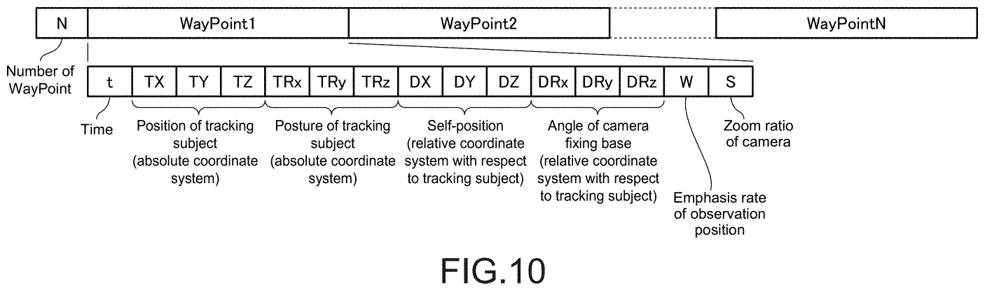

As shown in FIG. 10, at the current position in which the moving subject which is the tracking subject is observed at a predetermined time and the scheduled position of the moving subject at the predetermined time, any index indicating what is and how much important (importance rate of observation position) may be added to the respective WayPoints constituting the flight plan.

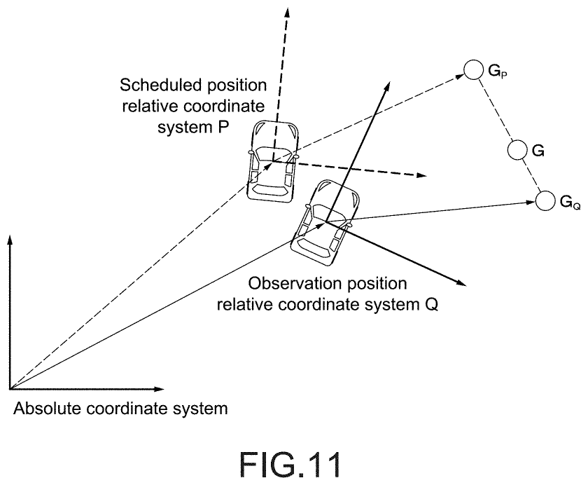

As shown in FIG. 11, the relative coordinate system based on the scheduled position described in each WayPoint of the moving subject which is the tracking subject is defined as a relative coordinate system P, and the control information corresponding to the scheduled position described in each WayPoint is defined as control information G_{P}. Furthermore, the relative coordinate system based on the current position (observation position) of the moving subject which is the tracking subject is defined as a relative coordinate system Q, and the control target value at the current position is defined as a control target value G_{Q}. The control object value G_{Q} can be obtained by the method described in the embodiment. An index indicating how much important the observed position, in other words, an index indicating which and how much important the control information G_{P} and the control target value G_{Q} is defined as W (where 0≤W≤1, 0 indicates importance of control information G_{P} (schedule value importance), and 1 indicates importance of a control target value G_{Q} (observation value importance)).

The control target value calculation unit 53 calculates the control target value G actually applied to the drone 5 by performing the calculation taking the index W into consideration. The control target value G is calculated by, for example, the following equation.

G=G_{P}*(1−W)+G_{Q}*W

For example, the flight plan may be created with the intention of capturing the certain moving subject at the predetermined angle or the like and also capturing a background thereof (body, advertisement, etc. to be captured together with famous scene or moving subject). In such a case, by appropriately setting the index W, while capturing the moving subject at substantially the same angle as the predetermined angle or the like, it is possible to capture an image in which the desired background is captured.

### Second Modification Embodiment

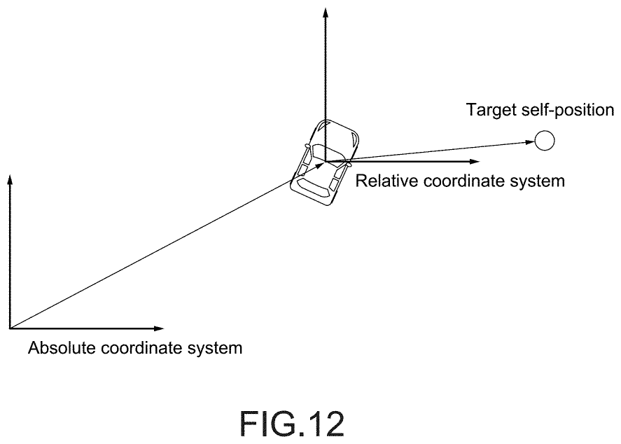

Depending on the use case of the drone 5, the posture (direction) of the observed tracking subject may be ignored. For example, when a ball is tracked in a soccer relay, it is necessary to follow a position of the ball, but it is no meaning that an angle of view is adjusted corresponding to a rotational posture of the ball. Also, even in the case of tracking a soccer player, it may be better to set the angle of view as a reference on a direction of a goal of a field or the like instead of setting a direction to the player who changes the direction frequently. In this case, as shown in FIG. 12, the position of the moving subject which is the tracking subject is set as the origin of the control information in the relative coordinate system, a direction of each axis is set coinciding with the absolute coordinate system, and the calculation of the control target value may be performed. The resulting control target value is also set in the relative coordinate system in which the direction of each axis is coincided with the absolute coordinate system by setting the position of the moving subject which is tracking subject as the origin.

### Other Modification Embodiments

Other modification embodiments will be described. The flight plan or WayPoint data may be provided in real time from the external device to the drone. A buffer memory for temporarily storing the WayPoint data or the like provided in real time may also be the storage unit. In addition, the storage unit may be a USB (Universal Serial Bus) memory or the like that is attached to and detached from the drone.

The camera may be a camera unit that is attachable/detachable to/from the drone, and the drone does not necessarily need to include the camera.

The present disclosure may also be implemented by an apparatus, a method, a program, a system, or the like. For example, a program that performs the functions described in the above embodiments can be downloaded, and a device that does not have the functions described in the above embodiments can perform the control described in the above embodiments in the device by downloading and installing the program. The present disclosure can also be realized by a server that distributes such a program. The present disclosure can also be realized as a tool for easily creating the flight plan described in the embodiments. The items described in the respective embodiments and the modification embodiments can be combined as appropriate.

The effects described herein are not necessarily limited and may be any of the effects described in this disclosure. Further, content of the present disclosure are not to be construed as being limited due to the illustrated effects.

The present disclosure may also take the following configurations.

(1)

A flight body, including:

a recognition unit that recognizes a current position of a moving subject that is a tracking subject;

a storage unit that stores control information corresponding to each of a plurality of scheduled positions of the moving subject;

a calculation unit that calculates control target information corresponding to the current position of the moving subject recognized by the recognition unit on a basis of the control information; and

a control unit that performs control according to the control target information.

(2)

The flight body according to (1), in which

the control unit controls a self-position according to the control target information.

(3)

The flight body according to (1), including:

an imaging unit, and in which

the control unit controls a setting of the imaging unit according to the control target information.

(4)

The flight body according to (1) or (2), in which

the setting of the imaging unit includes at least one of a posture of the imaging unit or a parameter of the imaging unit.

(5)

The flight body according to any of (1) to (4), in which

the calculation unit calculates the control target information on a basis of control information corresponding to each of a plurality of scheduled positions close to the current position of the moving subject.

(6)

The flight body according to (5), in which

the calculation unit calculates the control target information by performing calculation corresponding to a distance between the current position of the moving subject and each scheduled position with respect to each piece of control information.

(7)

The flight body according to any of (1) to (6), in which

the calculation unit determines a scheduled route obtained as continuous data of the scheduled positions, determines a nearest neighbor position closest to the current position of the moving subject on the scheduled route, and calculates the control target information at the nearest neighbor position.

(8)

The flight body according to (7), in which

the calculation unit calculates the control target information by performing weighted addition according to a distance between the nearest neighbor position and each scheduled position with respect to the control information corresponding to each of the two scheduled positions adjacent to the nearest neighbor position.

(9)

The flight body according to (7), in which

the nearest neighbor position corresponding to the current position of the moving subject is searched within a certain range from the nearest neighbor position obtained last time in the scheduled route.

(10)

The flight body according to any of (1) to (9), in which

an index indicating which of the scheduled position of the flight body at a predetermined time and the current position of the flight body at the predetermined time is to be regarded as important is stored corresponding to each of the plurality of scheduled positions, and

the calculation unit calculates the control target information by performing calculation using the index.

(11)

The flight body according to any of (1) to (10), in which

the control target information is information set in a coordinate system in which the current position of the moving subject is set as an origin and a direction is determined by the posture of the moving subject.

(12)

The flight body according to any of (1) to (10), in which

the control target information is information set in a coordinate system in which the current position of the moving subject as an origin and a direction of each axis is set coinciding with an absolute coordinate system.

(13)

The flight body according to any of (1) to (12), in which

the recognition unit recognizes the specified moving subject.

(14)

The flight body according to any of (1) to (13), in which

the recognition unit recognizes the moving subject on a basis of at least one of an image imaged by the imaging unit or information obtained on a basis of communication with outside.

(15)

An information processing method, including:

recognizing a current position of a moving subject which is a tracking subject by a recognition unit;

storing control information corresponding to each of a plurality of scheduled positions of the moving subject by a storage unit;

calculating control target information corresponding to the current position of the moving subject recognized by the recognition unit on a basis of the control information by a calculation unit; and

performing control according to the control target information by a control unit.

(16)

A program for causing a computer to execute an information processing method, the method including:

recognizing a current position of a moving subject which is a tracking subject by a recognition unit;

storing control information corresponding to each of a plurality of scheduled positions of the moving subject by a storage unit;

calculating control target information corresponding to the current position of the moving subject recognized by the recognition unit on a basis of the control information by a calculation unit; and

performing control according to the control target information by a control unit.

### Application Examples of the Disclosure

Next, application examples of the present disclosure will be described. It should be noted that the content of the present disclosure is not limited to the application examples shown below.

### (A) Example of Applying Drone to Tracking Subject Running Particular Trajectory

A1: In Shooting Movies, Commercials, Etc., a Scene in which a Car, Etc., is Shot from Outside

It is possible to perform shooting of a complicated route which is impossible by manual control of a human. Even if a movement of a tracking subject such as a car is slightly deviated from the schedule, it is possible to shoot a desirable picture.

### A2: Relay of Car Races Such as F1, a Horse Race, a Bicycle Race, a Boat Race, Marathon, and a Land Truck Race

It is possible to shoot a special image by automatic control, such as a viewpoint from which a dynamic image in a curve and a viewpoint from just side at which winning and losing can be easily understood.

(B) Tracking Subject that Travels within Particular Range with No Trajectory being Fixed

### B1: Relay of Field Sports Such as Soccer, Rugby, and American Football

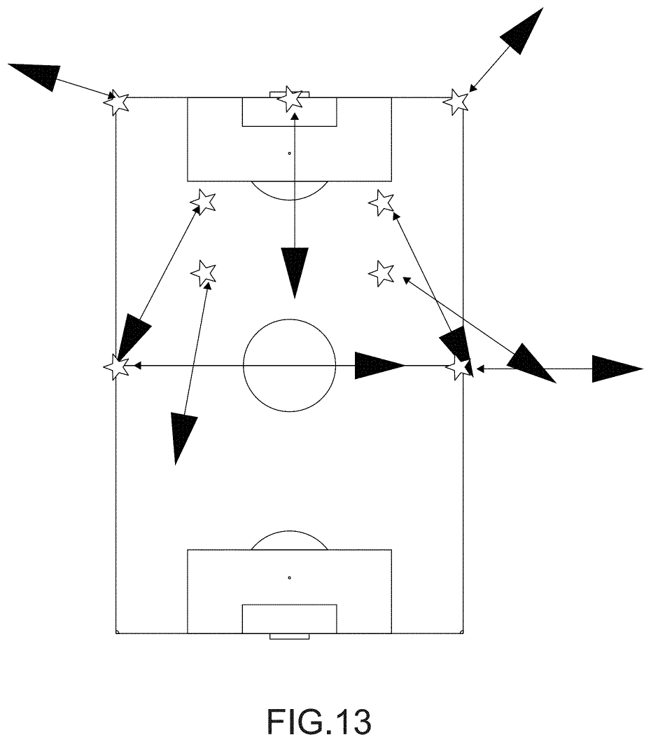

As schematically shown in FIG. 13, a large field can be relayed near players and can be shot at an effective angle of view according to the scene. Star marks indicate positions of the players, and black triangles indicate positions of a drone for shooting the players (arrows indicate shooting directions) in FIG. 13.

B2: Customer Service at Theme Parks and Tourist Destinations, where Drone Shoots Commemorative Photos and Videos to Specific Customers on a Day-to-Day Basis

When passing through various spots in the theme park, the angle of view can be automatically captured without manual intervention so that a famous building or the like of the theme park appears on the background.

In common with any of the above-described application examples, the following effects can be obtained.

Shooting can be performed without manual interventions.

Since it is possible to designate where and how to shoot, it is possible to take a special video with a rich sense of realism and the like.

Even if the tracing subject moves somewhat out of schedule, the subject can be shot without any problem.

### REFERENCE SIGNS LIST

5 drone
52 tracking subject recognition unit
53 control target value calculation unit
54 control unit
54A movement control unit
54B capturing control unit
55 camera
56 storage unit

1. A flight body, comprising:
a recognition unit that recognizes a current position of a moving subject that is a tracking subject;
a storage unit that stores control information corresponding to each of a plurality of scheduled positions of the moving subject;
a calculation unit that calculates control target information corresponding to the current position of the moving subject recognized by the recognition unit on a basis of the control information; and
a control unit that performs control according to the control target information.

2. The flight body according to claim 1, wherein
the control unit controls a self-position according to the control target information.

3. The flight body according to claim 1, comprising:
an imaging unit, and wherein
the control unit controls a setting of the imaging unit according to the control target information.

4. The flight body according to claim 3, wherein
the setting of the imaging unit includes at least one of a posture of the imaging unit or a parameter of the imaging unit.

5. The flight body according to claim 1, wherein
the calculation unit calculates the control target information on a basis of control information corresponding to each of a plurality of scheduled positions close to the current position of the moving subject.

6. The flight body according to claim 5, wherein
the calculation unit calculates the control target information by performing calculation corresponding to a distance between the current position of the moving subject and each scheduled position with respect to each piece of control information.

7. The flight body according to claim 1, wherein
the calculation unit determines a scheduled route obtained as continuous data of the scheduled positions, determines a nearest neighbor position closest to the current position of the moving subject on the scheduled route, and calculates the control target information at the nearest neighbor position.

8. The flight body according to claim 7, wherein
the calculation unit calculates the control target information by performing weighted addition according to a distance between the nearest neighbor position and each scheduled position with respect to the control information corresponding to each of the two scheduled positions adjacent to the nearest neighbor position.

9. The flight body according to claim 7, wherein
the nearest neighbor position corresponding to the current position of the moving subject is searched within a certain range from the nearest neighbor position obtained last time in the scheduled route.

10. The flight body according to claim 1, wherein
an index indicating which of the scheduled position of the flight body at a predetermined time and the current position of the flight body at the predetermined time is to be regarded as important is stored corresponding to each of the plurality of scheduled positions, and
the calculation unit calculates the control target information by performing calculation using the index.

11. The flight body according to claim 1, wherein
the control target information is information set in a coordinate system in which the current position of the moving subject is set as an origin and a direction is determined by the posture of the moving subject.

12. The flight body according to claim 1, wherein
the control target information is information set in a coordinate system in which the current position of the moving subject as an origin and a direction of each axis is set coinciding with an absolute coordinate system.

13. The flight body according to claim 1, wherein
the recognition unit recognizes the specified moving subject.

14. The flight body according to claim 1, wherein
the recognition unit recognizes the moving subject on a basis of at least one of an image imaged by the imaging unit or information obtained on a basis of communication with outside.

15. An information processing method, comprising:
recognizing a current position of a moving subject which is a tracking subject by a recognition unit;
storing control information corresponding to each of a plurality of scheduled positions of the moving subject by a storage unit;
calculating control target information corresponding to the current position of the moving subject recognized by the recognition unit on a basis of the control information by a calculation unit; and
performing control according to the control target information by a control unit.

16. A program for causing a computer to execute an information processing method, the method comprising:
recognizing a current position of a moving subject which is a tracking subject by a recognition unit;
storing control information corresponding to each of a plurality of scheduled positions of the moving subject by a storage unit;
calculating control target information corresponding to the current position of the moving subject recognized by the recognition unit on a basis of the control information by a calculation unit; and
performing control according to the control target information by a control unit.
